(19) United States
(12) Patent Application Publication
(10) Pub. No.: US 2009/0215387 A1
(43) Pub. Date: Aug. 27, 2009

(54) IN-VEHICLE CELLULAR DEVICE BLOCKER TO RESTRICT CELLULAR USE FOR OPERATOR

(76) Inventors: Joseph P. Brennan, Doylestown, PA (US); Eyal Adi, Doylestown, PA (US); William C. Campbell, Doylestown, PA (US)

Correspondence Address: RYDER IP LAW, PC, 107 NORTH BROAD STREET, SUITE 109, DOYLESTOWN, PA, 18901, US

(21) Appl. No.: 12/355,604

(22) Filed: Jan. 16, 2009

Related U.S. Application Data
(60) Provisional application No. 61/021,363, filed on Jan. 16, 2008.
(60) Provisional application No. 61/081,382, filed on Jul. 16, 2008.

(51) Int. Cl. H04K 3/00

(52) U.S. Cl. 455/1

(57) ABSTRACT

In general, in one aspect, the disclosure describes a narrow beam jammer to generate jamming signals for the regional cellular frequency ranges for use in vehicles. The narrow beam is directed at the location of the driver so that jamming and detection of communications is limited thereto. The initiation of the jammer may also be based on other parameters such as vehicle speed and Bluetooth synchronization. Other embodiments are described and claimed.

### PRIORITY

This application claims the priority under 35 USC §119 of Provisional Applications Nos. 61/021,363 entitled “Cell Blocking Device” filed on Jan. 16, 2008 and having Joseph P. Brennan, Eyal Adi, William C. Campbell and Dana S. Shute as inventors, and 61/081,382 entitled “In-Vehicle Cellular Device Jammer” filed on Jul. 16, 2008 and having Joseph P. Brennan, Eyal Adi, and William C. Campbell as inventors. Applications Nos. 61/021,363 and 61/081,382 are herein incorporated by reference in their entirety but are not prior art.

### BACKGROUND

The use of wireless devises such as cellular phones and personal digital assistants (PDAs) continues to grow. The wireless devices enable users to communicate with others via voice or text, access the Internet, and keep lists and/or schedules from almost any location. Users of wireless devices may use the devices even while they are operating vehicles including but not limited to cars, trucks, buses, trains, and boats. Using the devices while operating the vehicles may distract the user while the user is operating the vehicle. The distraction caused by the use of the wireless devices may result in accidents that result in property damage, injury and/or death to not only the operator of the vehicle but any passengers in the vehicle and other individuals or property that may come in contact with the vehicle.

Many states and locales have adopted rules regarding the use of wireless devices while operating a vehicle. The rules may range from banning the use of the devices while driving to restricting the use in some manner. The rules implemented have had limited success in reducing the use of wireless devices while operating vehicles.

Signal jammers could be utilized to prevent the use of wireless devices within the vehicles. However, the use of the jammers would likely interfere with the communications of more than just the operator of the vehicle. Furthermore, the use of a jammer may block other wireless communications besides that associated with the use of wireless devices. The 1934 telecommunications act (47 U.C.S. 333) makes it illegal to willfully or maliciously interfere with or cause interference to any radio communications of any station licensed or authorized by or under this Act or operated by the United States Government.

What is needed is a means for restricting the use of wireless devices in a vehicle that is limited to the operator of the vehicle. The public safety provided by the restriction and the limitation of the blocking to the wireless devices and to the operator of the vehicle could be allowed under the telecommunications act.

### BRIEF DESCRIPTION OF THE DRAWINGS

The features and advantages of the various embodiments will become apparent from the following detailed description in which:

FIG. 1 illustrates a high level functional block diagram of an example jamming device that may be utilized to block communications of an operator of a vehicle, according to one embodiment;

FIG. 2 illustrates a block diagram of an example jamming signal generator, according to one embodiment;

FIG. 3 illustrates an example narrow beam antenna, according to one embodiment;

FIG. 4 illustrates an example beam that may be generated by a narrow beam antenna, according to one embodiment;

FIGS. 5a-d illustrates an example operator of a vehicle and the placement of the antenna in several locations to direct the narrow beam at the driver, according to one embodiment;

FIG. 6 illustrates a high level functional block diagram of an example jamming device that may be utilized to block communications of an operator of a vehicle, according to one embodiment;

FIG. 7 illustrates an example block diagram of an in-vehicle narrow beam cellular communications jamming device, according to one embodiment; and

FIG. 8 illustrates an example truth table that may be utilized by the controller to determine when jamming should occur, according to one embodiment.

### DETAILED DESCRIPTION

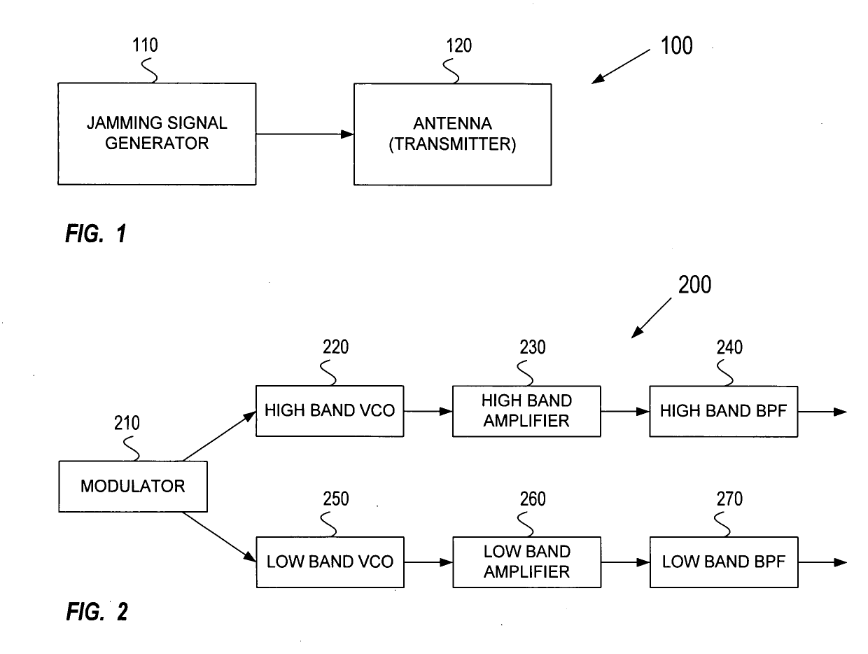

FIG. 1 illustrates a high-level functional block diagram of an example jamming device 100 that may be utilized to block communications of an operator of a vehicle. The device 100 may be configured to be installed in a vehicle and only operate within the vehicle so as to limit the application of the jamming to the vehicle. The device 100 may be designed for one or more frequency bands associated with regional cellular communications (e.g., talking, texting). For example, the device 100 may be designed to cover any or all cellular/PCS systems including but not limited to global system for mobile communications (GSM), code division multiplex access (CDMA), wideband CDMA (WCDMA) and all US and international frequency division duplex, time division duplex and code division duplex variants. Band coverage may include but is not limited to 700, 850, 900, 1800, 2100 MHz communication bands. The ranges are in no way limited to the number of bands or ranges defined as new bands are always emerging.

The device 100 may be consolidated into a number of bands. For example, the device 100 may include two bands (e.g., a low band and a high band). The low band may cover the frequency bands between approximately 700 to 900 MHZ and the high cover the frequency bands between approximately 1800 to 2100 MHz. The number and range of bands is in no way limited to those noted above. Rather, the bands can be defined to account for the current cellular frequency ranges then in place for the specific region.

The device 100 may be designed to limit the range of jamming to at or near the location of the operator of the vehicle (e.g., the driver). The limited range may be obtained by transmitting the low power jamming signal within a narrow beam that is directed at the driver. The limiting of the device 100 to a vehicle, to a specific location in the vehicle and to specific frequencies associated with cellular communications and at reduced radiation power level limits the interference with radio communications to the type of communications that are illegal in many jurisdictions due to the public safety issues associated therewith (e.g., use of wireless device while driving).

The device 100 may include a jamming signal generator 110 and an antenna 120. The jamming signal generator 110 may generate a jamming signal for the different frequency bands defined (e.g., high band, low band). The jamming signal for each frequency band may be capable of restricting communications within that band. The antenna 120 may transmit the jamming signal for the particular band within the associated frequency range for the band.

The jamming signal generator 110 may be multi-banded and cover the major bands for regional mobile communication (e.g., high and low bands as described above). Each band may have a separate voltage controlled oscillator (VCO) that may be tuned to the center of the band. The output of the VCOs may be modulated (swept) across the frequency spectrum. The output of the VCOs may be amplified to increase the gain and may be filtered to limit out of band spurious signals. The resultant output power of the jamming signal generator may be approximately +5 dBm.

FIG. 2 illustrates a block diagram of an example jamming signal generator 200 (e.g., 110 of FIG. 1). The jamming signal generator 200 may include a modulator 210, a high band VCO 220, a high band amplifier 230, a high band band pass filter (BPF) 240, a low band VCO 250, a low band amplifier 260, and a low band BPF 270.

The modulator 210 may be an oscillator, such as a frequency oscillator. The frequency may be small compared to the frequency of the various bands defined therein (e.g., in the range of 75 KHz). The modulator 210 may provide a stepped saw tooth waveform. The shape and frequency of the waveform is in no way intended to be limited thereto. Rather various other frequencies and waveforms can be used including random shapes and/or frequencies (noise) without departing from the scope.

The high band VCO 220 may generate a waveform that may be at a frequency that is the center of the frequency band of the cellular communications band down link for high band channels. For example, if the high band frequency range is 1800-2000 MHz, the high band VCO may generate a 1900 MHz waveform. The high band VCO 220 receives the modulation signal from the modulator 210 and varies the VCO frequency up and down (e.g., at the 75 KHz rate) based thereon.

The high band amplifier 230 amplifies the gain of the waveform generated by the high band VCO 220. The amplified high band signal is provided to the high band BPF 240 to filter unwanted out of band frequencies.

The low band VCO 250, amplifier 260 and BPF 270 may operate in the same fashion as the high band devices but at the lower frequency band.

The jamming signal generator 200 is not limited to the illustrated embodiment described above. Rather, any type of jamming signal generator that can generate jamming signals for specific frequency ranges (bands) could be utilized and is within the current scope.

Referring back to FIG. 1, the antenna 110 may also be multi-banded to cover the major bands for regional mobile communication (e.g., high and low bands as described above). The antenna 110 may be capable of transmitting the appropriate jamming signal within the defined band. The antenna 110 may include a separate antenna associated with each band. The antenna(s) 110 may provide a narrow beam for the specific bands. The antenna 110 may be a patch antenna design or a spiral antenna design to provide the narrow beam. The antenna 110 may be placed within the vehicle so that the narrow beam may be directed at the location of an operator of a vehicle (e.g., drivers seat). The antenna 110 design and placement may limit the transmission of the jamming signal to at or near the location of the operator (e.g., driver).

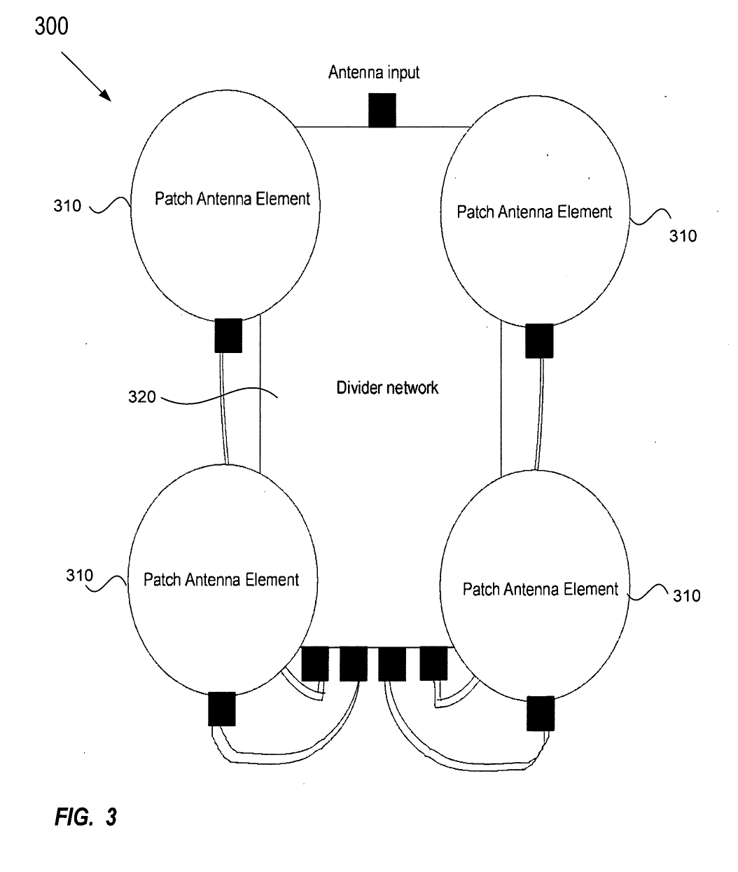

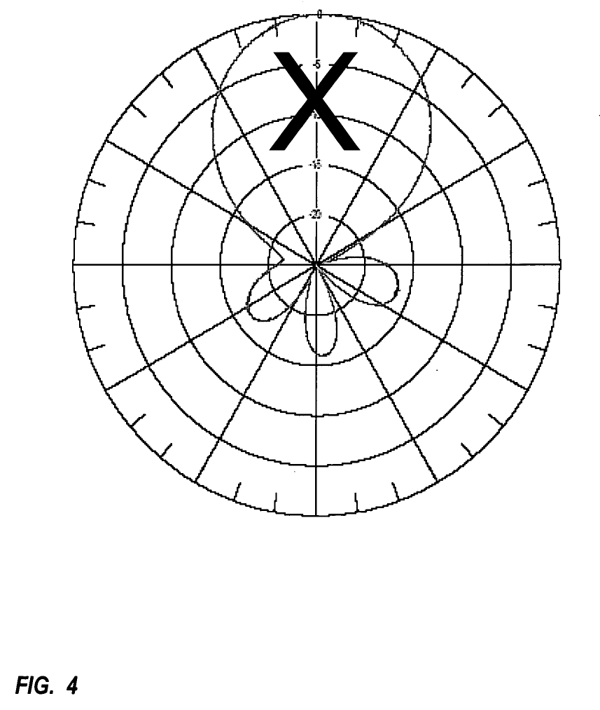

FIG. 3 illustrates an example narrow beam antenna 300 (e.g., 110 of FIG. 1). The narrow beam antenna 300 may include a plurality of patch antenna elements 310 and a divider network 320. As illustrated the antenna 300 includes four patch antenna elements 310 at the corners of the antenna 300 and the divider network 320 is located between the patch antenna elements 310. The divider network 320 divides the signal received or transmitted by the antenna 300 (e.g., the jamming signal) and provides part of the signal to each of the patch antenna elements 310. The use of multiple patch antenna elements 310 to transmit a portion of the signal may provide the narrow beam. The patch antenna elements 310 and the divider network 320 may be relatively thin so the antenna 300 may be relatively thin as well (have a low profile). The low profile may assist in locating the device 100 within a vehicle.

The number and arrangement of the patch antenna elements 310 and location of the divider network 320 are in no way intended to be limited to the illustrated embodiment. The number and location of the antenna elements 310 may be selected based on the frequency band of the antenna 300 and the desired band width of the beam (e.g., how narrow). The number and location of the antenna elements 310 may also be based on the desired physical layout of the antenna 300.

The narrow beam antenna 300 is not limited to the illustrated embodiment described above. Rather, the antenna may be a spiral antenna or any type of antenna that provides a narrow beam jamming signal for specific frequency ranges (bands) and can be used to limit the jamming of cellular devices to the location of the driver is within the current scope.

FIG. 4 illustrates an example beam that may be generated by a narrow beam antenna (e.g., 300 of FIG. 3). The antenna is located at the center dot and the beam is directed substantially forward from the antenna (in a straight line up from the center dot) and does not extend to far (e.g., no more than 60 degrees) in either direction therefrom. The narrow beam could be focused on the driver (illustrated by the X) and not affect the passengers in the front or back seats or others outside of the vehicle. The strength of the transmission from the antenna could be adjusted to account for the vehicle that the device 100 is being installed in. For example, for larger vehicles the transmission strength may need to be increased to ensure that signal reaches the driver and the smaller the vehicle the less the transmission strength may be required.

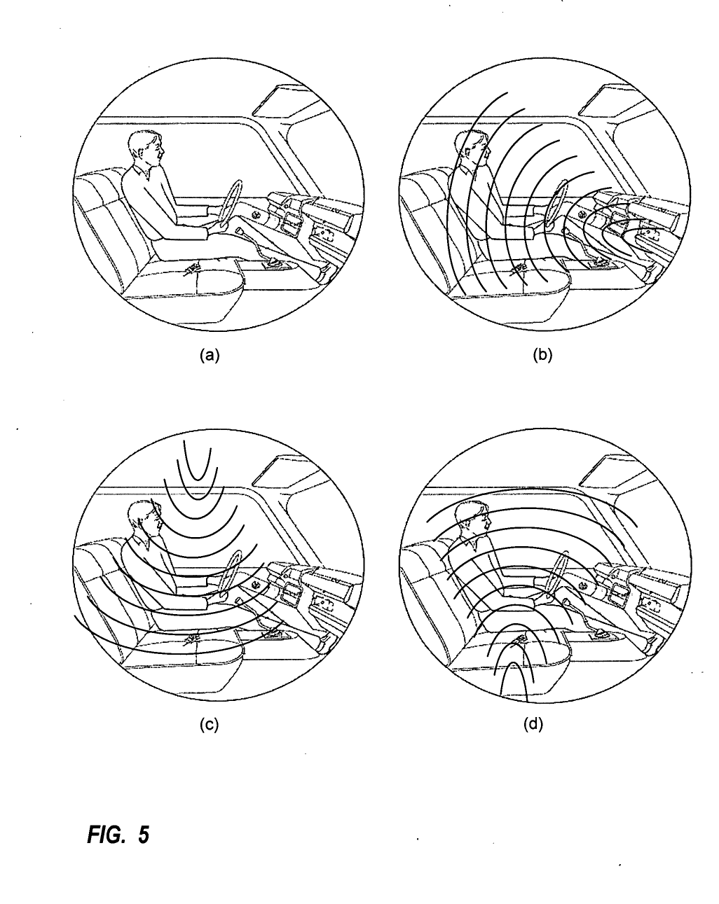

FIGS. 5a-d illustrates an example operator of a vehicle (e.g., driver of a car) and the placement of a narrow beam antenna (e.g., 300 of FIG. 3) in several locations to direct the narrow beam at the driver. FIG. 5a illustrates the personal space associated with a driver of a car. FIG. 5b illustrates the narrow beam antenna being located under or in the dash and transmitting the jamming signals at the driver. FIG. 5c illustrates the narrow beam antenna being located in the headliner of the vehicle and the jamming signal being transmitted down to the driver. FIG. 5d illustrates the narrow beam antenna being located under the seat and transmitting the signal up to the driver. The placement of the antenna will be such that the jamming signal will be substantially limited to the location of the driver.

Referring back to FIG. 1, the device 100 didn't describe where is was receiving power from. The power may be received directly from the vehicle (e.g., may be connected to the vehicle battery). The device 100 may include a power conditioner (converter) to convert the voltage of the vehicle (e.g., 12 V) to the voltage necessary to operate the device (e.g., 5 V). As the device is designed to jam cellular devices of a vehicle operator while the vehicle is in operation the device 100 may not need to be powered on if the car is not in operation. For example, many of the laws restricting cellular usage instruct drivers to pull over if they need to make a call. If the device was active when the driver pulled off the road and turned their car off the driver would still be precluded from making a call even when they were following the law. Such usage of the device would likely be a violation of the 1934 telecommunications act. Accordingly, the device 100 may be connected to ignition power only (power is only received if the ignition is enabled) so that the device is not enabled unless the vehicle is on.

The device 100 is not limited to receiving power from the vehicle. Rather, the device 100 may receive power from any number of power sources including, but not limited to, batteries, solar devices, and wind power devices. The power source may be connected to the device 100 via the ignition so that the device 100 is not powered unless the vehicle ignition is enabled.

The device 100 may be providing jamming signals even if the operator of the vehicle is not using a cellular device. The device 100 may not want to activate the jamming capabilities until the use of a cellular device is detected.

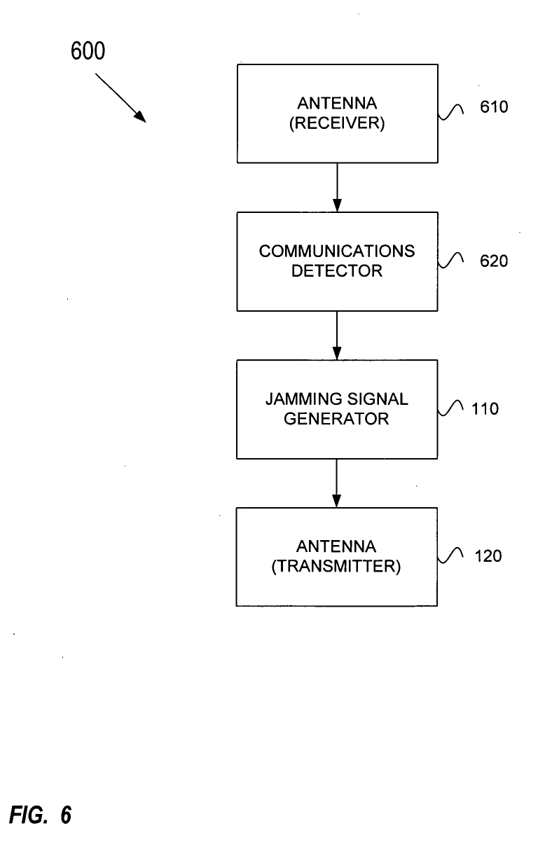

FIG. 6 illustrates a high level functional block diagram of an example jamming device 600 that may be utilized to block communications of an operator of a vehicle. The device 600 may be similar to the device 100 and include the jamming signal generator 110 and the transmitting antenna 120 and may also include a receiving antenna 610 and a communications detector 620. The receiving antenna 610 may be a narrow beam antenna capable of receiving (detecting) wireless communications signals associated with a cellular device of the user of the vehicle (e.g., driver of the car). The receiving antenna 610 may be capable of receiving signals within specific frequency ranges associated the cellular bands used in each target market. For example, the antenna 610 may include a high band to receive communications in the high band of the cellular spectrum and a low band to receive cellular communications in the low band of the cellular spectrum. The antenna 610 may include a separate antenna associated with each band. The antenna 610 may provide a narrow beam receive pattern to limit the area within which communications can be detected. The antenna 610 may be a patch antenna that enables the generation of the narrow beam. The antenna 610 may be a low profile antenna. The antenna 610 may be placed so that the narrow beam may be directed at the location of an operator of a vehicle (e.g., drivers seat). The antenna design and placement may reduce outside pick-up beyond the driver area.

The antenna 610 may be connected to the communications detector 620 so that any signals received are passed thereto. The communications detector 620 may include band pass filters for each defined band so that any signals received outside of that range are ignored. If the communications detector 620 detects cellular communications (e.g., communications from the wireless device to a base station), it may provide the jamming signal generator 110 instructions to begin generating the jamming signals.

The jamming signal generator 110 may generate jamming signals for all frequency bands regardless of which frequency band the communications was detected on. Alternatively, the jamming signal generator 110 may generate the jamming signal for just the band where the communications was detected.

When the jamming signal generator 110 is active the receive antenna 610 may be turned off as communications should not be occurring. The receive antenna may be turned off for all bands, just the band where communications was previously detected, or just the band where jamming is occurring.

The transmit and the receive antenna 110, 610 may be the same device. The function performed by the antenna 110/610 may be controlled based on conditions of the device 600 (e.g., a controller may be used to make the determination). For example, the antenna 110/610 may be in a receive mode upon initiation and remain in the receive mode until communications are detected. Once communications are detected the antenna 110/610 may switch to a transmit mode. The antenna 110/610 may switch to a transmit mode when jamming signals are provided thereto.

The design of the antenna 110/610 is unique in its focus to the target cellular bands in frequency coverage and beam width. Distinct shapes may be developed to cover each target cellular band. The beam is focused specifically to reduce external interference and concentrate the radiated energy to the driver area and narrow the receive pattern to reduce outside pick-up beyond the driver area. The specific design enables the unit to have a thin profile so that in vehicle mounting can be accomplished easily.

In addition to controlling the device 600 based on the ignition of the vehicle being initiated and detecting cellular communications from the location of the operator of the vehicle (e.g., driver of the car), the operation of the device can be controlled based on other parameters as well. For example, the device 600 may not be activated unless the vehicle is going over a certain speed, or the device 600 may be deactivated if the operator is using a Bluetooth hands free device. The number and type of parameters that may be utilized to control the device 600 is in no way intended to be limited to the above mentioned parameters.

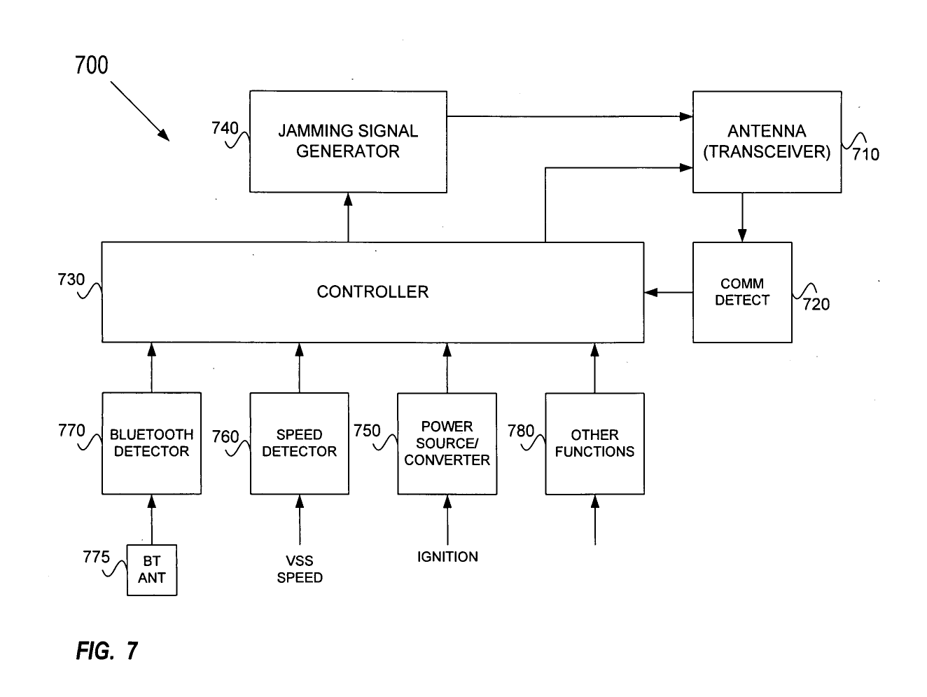

FIG. 7 illustrates an example block diagram of an in-vehicle narrow beam cellular communications jamming device 700. The device 700 is designed to restrict the jamming to the regional cellular bands and to the location of the operator of the vehicle. The device 700 includes a narrow beam antenna 710, a communications detector 720, a controller 730, a jamming signal generator 740, a power source/power converter 750, a speed detector 760 and a Bluetooth detector 770. The device 700 may also include other functions 780 that may detect various parameters.

The narrow beam antenna 710 may be associated with one or more frequency bands for regional cellular communications (a multi-band antenna). The antenna 710 may be capable of transmitting and receiving within the defined bands. As receive antennas, they may receive local cellular transmissions generated by the driver's cell phone when attempting to communicate with the cellular network. As transmit antennas, they transmit jamming signals.

The antenna 710 may include a separate antenna for each band. The antenna may be designed to provide a narrow beam directed at the driver to reduce external interference and concentrate the radiated energy to the driver area and narrow the receive pattern to reduce outside pick-up beyond the driver area. The antenna 710 may include a transmit/receive switch to select what mode the antenna 710 is operating in. The switch may be located at the input/output of each antenna and may be switched by commands from the controller 730. The antenna 710 may be used in a receive mode until a blocking signal is sent by the transmitter whereby the switch changes to the transmit configuration.

The antenna 710 may also include an attenuator that may be used to attenuate both transmit and receive power. Adjusting the attenuator for transmit allows custom power control for adjusting individual vehicle system performance. The attenuator may be programmable through the controller 730. Also while in the receive channel, the attenuator allows reduction of the receiver sensitivity for localizing radio frequency (RF) power reception limited to the driver seat area. The attenuator may be programmed by a technician when the device is installed in the vehicle.

The communications detector 720 may receives signals from the antenna 710 by and detect RF signal transmissions in the local area covered by the directive antenna. When RF is detected, signaling the presence of a cellular transmission from inside the vehicle, a logic signal may be sent to the controller 730 informing the controller 730 of the fact the communications is occurring in the driver seat. The communications detector 720 may include a selectable band pass receiver for each band.

The controller 730 may receive input from various sources (the power source/power converter 750, the speed detector 760, the Bluetooth detector 770, and the other functions 780) and make a determination with regard to jamming. The controller 730 may control the operation of the jammer 740 and may also control the switching of the antenna 710 between transmit and receive modes. The controller 730 may control the operation of the jammer by controlling the application of power thereto. The controller 730 may also be able to adjust the attenuation of the antenna 710. The controller 730 may be hardware, software and/or firmware. The controller 730 may be programmed by a technician. Some functions of the controller may be programmed by a user. The user may program the controller using a software application that possibly is run on a wireless device (e.g., PDA).

The jammer 740 may be a multi-banded jammer that can provide jamming signals for the various frequency bands associated with regional cellular communications. The jammer 740 may create the jamming signals by sweeping a signal across the associated band. Each band may have a separate voltage controlled oscillator (VCO) that may be tuned to the center of the band. The output of the VCOs may be modulated (swept) across the frequency spectrum. The output of the VCOs may be amplified to increase the gain and may be filtered to limit out of band spurious signals.

The power source/power converter 750 may provide power to the device 700 and convert the power to the appropriate voltage necessary to operate the device 700. The power source may be the vehicle, a battery, or other power sources (e.g., solar, wind). The power source/power converter 750 may communication with the vehicle ignition and limit the application of power to the device to when the vehicle ignition is activated (the vehicle is on).

The speed detector 760 is in communication with a vehicle speed sensor (VSS) used to determine the speed of the vehicle. For example, most vehicles today are designed with a VSS encoder that counts 2k, 4k or 8k pulses per mile. This VSS information is then fed into the on board computer for further processing of gear selection, fuel mixture, etc. Another form of a VSS is a hall effect pickup. The pickup can be installed after market on the drive shaft of the vehicle. The speed of each half revolution is detected and is then converted to speed. Either method or others such as global positioning system (GPS) sensors may be used to determine speed of the vehicle. The control module may receive the VSS information from any of the devices and convert the information to speed. The controller may be configured during installation to the type of data that will be received and how that information is converted to speed or the specific vehicle. Alternatively, the speed detector 760 may be connected to the vehicle computer and receive the speed information directly therefrom.

The speed detector 760 may provide the speed to the controller 730. The controller 730 may be programmed to allow cellular communications (not activate the jammer 740) if the vehicle is going below some defined speed (e.g., 15 miles per hour). The controller may also be programmed to initiate jamming regardless of any other parameters (e.g., cell use detected, Bluetooth use) if the vehicle is going over a certain speed (e.g., 75 mph) as that speed may be deemed too dangerous even without taking into account any distractions that may be caused by cell phone usage.

The Bluetooth detector 770 may be connected to a Bluetooth transceiver 775. The transceiver 775 may be a class 1 Bluetooth receiver/transmitter that operates between 2.0 and 2.485 GHz and is fully programmed as a slave device. As with any Bluetooth slave device, the transceiver 775 is identified by a code and any Bluetooth enabled device (master) wishing to communicate therewith needs to enter the code in order to link to the slave. The transceiver 775 provides for synchronization/linking with a master device and/or hands free device through encrypted and secure protocols.

The Bluetooth transceiver 775 may be configured such that it only discovers devices that are within the driver seat of the vehicle. When a user with a Bluetooth enabled device (e.g., cell phone, PDA) enters the driver area of a vehicle having the device 700 and the devices are in discover mode the Bluetooth enabled device may detect the device 700 and ask for the code for the device 700. If the user has the code they can enter the code in order to complete the linking of the devices. The Bluetooth enabled device may maintain the code so that it need not be entered in the future to complete the linking of the devices.

Only authorized hands free devices having the proper pass code are allowed a secure connection to the transceiver 775. The owner of the vehicle should only provide the secure connection/synchronization code only to authorized personnel trusted to operate the vehicle safely. For example, parents may have the code programmed in their cell phones but may not provide the code to their teenage children. Trucking and bus companies may provide the code to experienced drivers but not to new drivers.

Following the completed handshake, the Bluetooth detector 770 may determine that a Bluetooth enabled device is being utilized and may provide that information to the controller 730. The controller 730 may make a determination that jamming should not occur if a Bluetooth enabled device is being utilized.

It should be noted that just because a Bluetooth enabled phone has linked with the device 700 does not actually mean that the user of the Bluetooth enabled device is utilizing the device in a hands free manner (e.g., utilizing a headset). The device 700 may also require the linkage with a hands free device before it disables jamming. It should be pointed out it is possible for the device to link with both the phone and the hands free device even though the phone is not using the hand free device (e.g., the hands free device may not be associated with the phone). Accordingly, the device 700 may require that the phone and the hands free device are associated with one another. The associations may be programmed into the device 700. The device 700 may require the phone and the hand free device to be linked. Proof of the linkage may be provided by the phone in some manner.

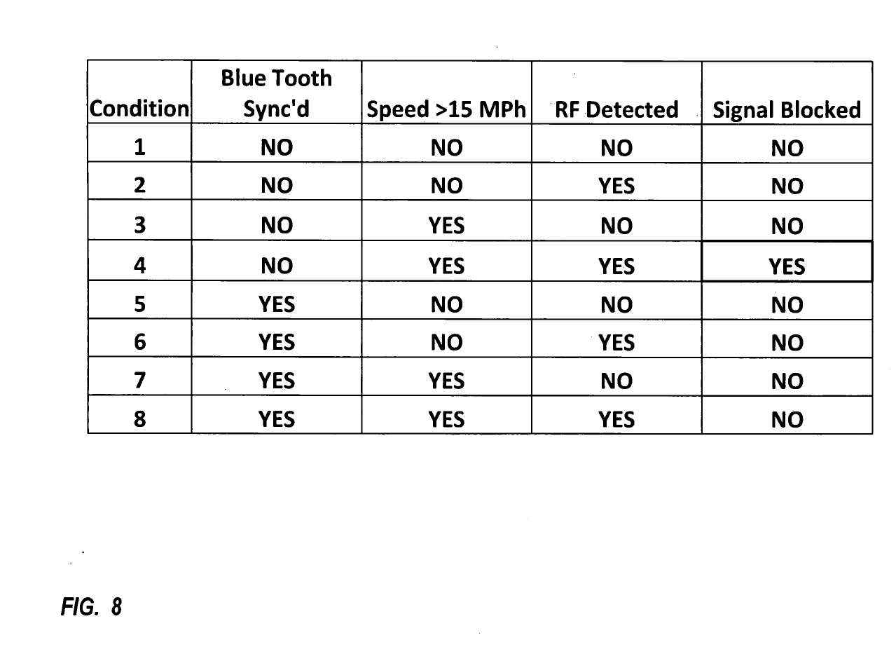

FIG. 8 illustrates an example truth table that may be utilized by the controller 730 to determine when jamming should occur. The truth table includes states related to the parameters defined above (speed, communications, Bluetooth) and defines when based on those states jamming should occur. The states defined are whether the device has been synced with blue tooth, whether the vehicle is going over 15 mph, and whether RF signals have been detected. Jamming may be limited to when Bluetooth is not synced, the vehicle is going over 15 mph, and RF signals have been detected. Accordingly, only condition 4 in the truth table would result in jamming.

The activation of jamming is in no way intended to be limited to the parameters or the stares of the parameters defined in the truth table. Other functions may provide parameters to the controller 730 and be utilized to determine when jamming should occur. For example, the system 700 may include an override switch that enables a driver to override the jamming. The jamming may be initiated if the vehicles windshield washers are on or the speed with which the car must be traveling above to disable jamming may be increased if the windshield wipers are on. The system many utilize the vehicle being in gear in place of the speed of the vehicle. The system may require that the vehicle has it hazards on in order to disable the jammer (or may disable the jammer if the hazards are on). One skilled in the art would recognize that the parameters that may be used and the application of the parameters that can be used to control the jamming is extensive.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A cellular device jammer integrated with a vehicle, comprising
a jamming signal generator to generate jamming signals for defined frequency ranges associated with regional cellular communications; and
a narrow beam antenna associated with the defined frequency ranges and directing a beam at an operator of the vehicle, to receive RF communications initiated from location of the operator and to transmit the jamming signal to the location.

2. The jammer of claim 1, wherein the beam is focused specifically to reduce external interference and concentrate radiated energy on the location and narrow receive pattern to reduce pick-up of RF signals outside the location.

3. The jammer of claim 1, wherein the antenna has a thin profile.

4. The jammer of claim 1, wherein the antenna is a patch antenna.

5. The jammer of claim 1, wherein the antenna is a spiral antenna.

6. The jammer of claim 1, wherein the jamming signal generator includes a VCO for each defined frequency range to generate the jamming signal.

7. The jammer of claim 6, wherein the jamming signal generator further includes a modulator to modulate the jamming signal across the frequency range.

8. The jammer of claim 1, further comprising a controller to determine when to activate the jamming signal generator.

9. The jammer of claim 8, wherein the controller is to switch the antenna between transmit and receive mode.

10. The jammer of claim 1, wherein power is provided by the vehicle.

11. The jammer of claim 1, wherein application of power to the jammer is controlled by ignition state of the vehicle.

12. The jammer of claim 1, further comprising a Bluetooth detector.

13. The jammer of claim 1, further comprising a vehicle speed detector.

14. The jammer of claim 1, further comprising a communication detector.

15. The jammer of claim 8, wherein the controller makes a determination based on various parameters provided thereto.

16. the jammer of claim 15, wherein the parameters include vehicles speed, Bluetooth synchronization, and cellular communication detection.

17. The jammer of claim 1, wherein the vehicle includes automobiles, school and public transportation buses, fleet vehicles, cargo carriers, trains, boats or anywhere humans are susceptible to distracted motor vehicle operation due to any type of cellular communications.
